(19) United States
(12) Patent Application Publication
(10) Pub. No.: US 2008/0030365 A1
(43) Pub. Date: Feb. 7, 2008

(54) MULTI-SENSOR WIRELESS TELEMETRY SYSTEM

(76) Inventors: Michael L. Fripp, Carrollton, TX (US); Kevin D. Fink, Frisco, TX (US); Neal G. Skinner, Lewisville, TX (US); Adam D. Wright, McKinney, TX (US); Vincent P. Zeller, Flower Mound, TX (US)

Correspondence Address: SMITH IP SERVICES, P.C., P.O. Box 997, Rockwall, TX, 75087, US

(21) Appl. No.: 11/459,402

(22) Filed: Jul. 24, 2006

(51) Int. Cl. G01V 3/00

(52) U.S. Cl. 340/853.1; 340/870.01

(57) ABSTRACT

A multi-sensor wireless telemetry system. A telemetry system includes multiple sensor assemblies, each sensor assembly including at least one sensor and a sensor data transmitter, and a transceiver which receives sensor data from each of the transmitters. An acoustic telemetry system includes multiple transmitters, and a transceiver. The transmitters transmit to the transceiver using one acoustic signal mode, and the transceiver transmits to a remote location using a different acoustic signal mode.

### BACKGROUND

The present invention relates generally to wireless telemetry systems and, in an embodiment described herein, more particularly provides a multi-sensor wireless telemetry system for use in conjunction with a subterranean well.

In the past, wireless telemetry systems for use in wellbores have typically utilized a sensor and a transmitter (or transceiver) to communicate sensor data from the wellbore to the surface. One or more repeaters may be used to relay the sensor data to the surface.

The sensor and transmitter are incorporated into an assembly, with the transmitter being designed for long-range transmissions of the sensor data. The transmitter is, therefore, relatively complex and expensive in design. If multiple sensors are used, the sensors will typically be hardwired to the same transmitter in order to forego the additional expense and signal interference associated with using multiple sensor/transmitter assemblies.

However, there are several disadvantages to this type of multi-sensor telemetry system. For example, distribution of the hardwired sensors is limited due to the problems associated with installing wires in hostile environments, routing the wires past obstructions, etc. As another example, this type of system is unable to take advantage of short-range signal transmission modes for communicating between the multiple sensors and the transmitter.

### SUMMARY

In carrying out the principles of the present invention, a wireless telemetry system is provided which solves at least one problem in the art. One example is described below in which short-range and long-range transmission modes are advantageously combined to enable communication with multiple sensor assemblies. Other examples are described below in which the sensor assemblies can transmit directly to a central long-range transmitter, the sensor assemblies can be used to relay data to the long-range transmitter and/or the sensor assemblies can form a network in which any of the sensor assemblies can communicate with any of the other sensor assemblies or the long-range transmitter.

In one aspect of the invention, a telemetry system is provided which includes multiple sensor assemblies, each sensor assembly including at least one sensor and a sensor data transmitter. A transceiver receives sensor data from each of the transmitters.

The system may use one signal mode for transmitting between the transmitters and the transceiver, and a different signal mode for transmitting between the transceiver and a remote location. Simultaneous transmissions may be distinguished by using different frequencies for each transmission, or by including unique codes in each transmission, etc. The transmissions between the transmitters and the transceiver may be centralized or decentralized, in series or parallel, etc. The sensors may be used to monitor distributed pressures, temperatures and/or other parameters associated with a subterranean wellbore or formation.

The transmitters may be associated with devices other than sensors, such as well tool actuators, etc. Any type of actuator or other device may be associated with the transmitters in any combination.

In another aspect of the invention, an acoustic telemetry system is provided which includes multiple transmitters and a transceiver. The transmitters transmit to the transceiver using one acoustic signal mode, and the transceiver transmits to a remote location using a different acoustic signal mode.

These and other features, advantages, benefits and objects of the present invention will become apparent to one of ordinary skill in the art upon careful consideration of the detailed description of representative embodiments of the invention hereinbelow and the accompanying drawings, in which similar elements are indicated in the various figures using the same reference numbers.

### BRIEF DESCRIPTION OF THE DRAWINGS

FIG. 1 is a schematic partially cross-sectional view of a well system embodying principles of the present invention;

FIG. 2 is a schematic partially cross-sectional view of an alternate configuration of the well system;

FIG. 3 is a schematic illustration of a decentralized telemetry system for use in the well system;

FIG. 4 is a schematic illustration of a centralized telemetry system for use in the well system;

FIG. 5 is a graph of different frequencies utilized for simultaneous transmissions in the telemetry system; FIG. 6 is an enlarged scale schematic view of a sensor assembly for use in the telemetry system; and

FIGS. 7 & 8 are schematic partially cross-sectional views of further alternate configurations of the well system and associated telemetry system.

### DETAILED DESCRIPTION

It is to be understood that the various embodiments of the present invention described herein may be utilized in various orientations, such as inclined, inverted, horizontal, vertical, etc., and in various configurations, without departing from the principles of the present invention. The embodiments are described merely as examples of useful applications of the principles of the invention, which is not limited to any specific details of these embodiments.

In the following description of the representative embodiments of the invention, directional terms, such as “above”, “below”, “upper”, “lower”, etc., are used for convenience in referring to the accompanying drawings. In general, “above”, “upper”, “upward” and similar terms refer to a direction toward the earth's surface along a wellbore, and “below”, “lower”, “downward” and similar terms refer to a direction away from the earth's surface along the wellbore.

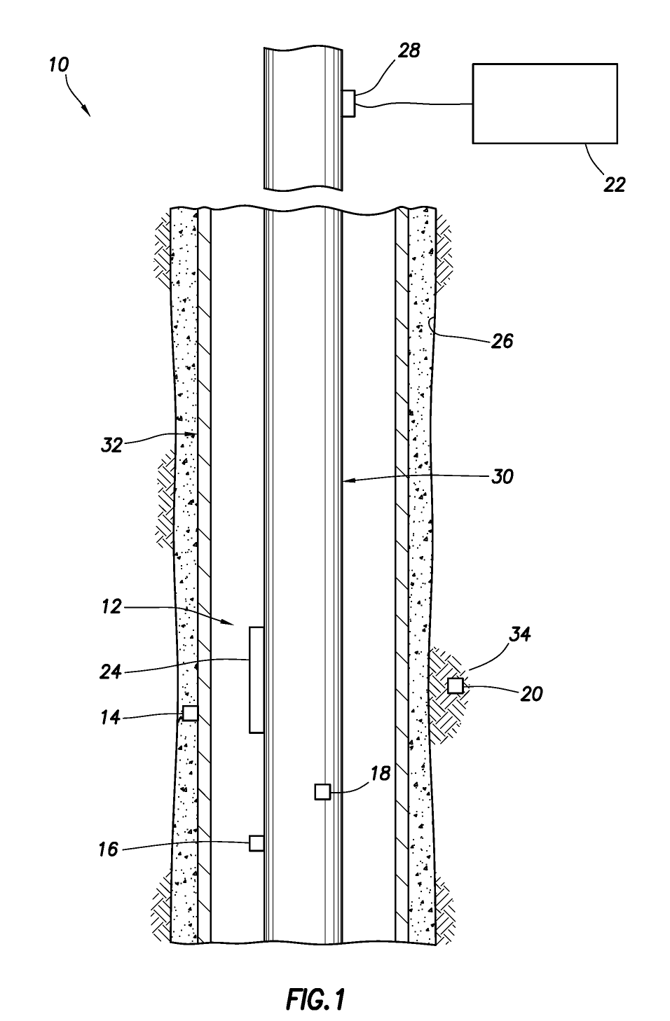

Representatively illustrated in FIG. 1 is a well system 10 which embodies principles of the present invention. The well system 10 includes a telemetry system 12 for transmitting data from multiple sensor assemblies 14, 16, 18, 20 to a surface data acquisition and control system 22. For this purpose, the telemetry system 12 includes a long-range transceiver 24 positioned in a wellbore 26, and a receiver 28 positioned at or near the surface.

In this example, the transceiver 24 communicates with the receiver 28 via acoustic stress waves transmitted via a tubular string or other type of transmission medium 30. However, it should be clearly understood that any type of telemetry may be used in the telemetry system 12 in keeping with the principles of the invention.

Each of the sensor assemblies 14, 16, 18, 20 includes a wireless transmitter or transceiver for short-range communication with the transceiver 24, either directly or via other of the sensor assemblies. In this manner, only the single long-range transceiver 24 is needed for communication between the sensor assemblies 14, 16, 18, 20 and the surface system 22. One or more repeaters may be used for very long distance communication between the transceiver 24 and the receiver 28.

Furthermore, the sensor assemblies 14, 16, 18, 20 can be positioned as desired without the complications of running wires or lines to the sensor assemblies. For example, the sensor assembly 14 can be positioned external to a casing or liner string 32 (e.g., in an annulus between the string and the wellbore 26), the sensor assembly 16 can be external to the tubular string 30, the sensor assembly 18 can be internal to the tubular string, and the sensor assembly 20 can be positioned in an earth formation 34 (e.g., via a perforation through the casing or liner string 32, not shown).

Since the well system 10 is merely one example illustrating principles of the invention, it will be appreciated that a wide variety of variations can be devised which still incorporate these principles. For example, it is not necessary for the transceiver 24 to communicate with the receiver 28 via the tubular string 30. Such communication could be via the casing or liner string 32, or via another form of telemetry (such as, a form of telemetry other than acoustic telemetry). The receiver 28 could include a transmitter for transmitting data and/or control signals to the transceiver 24 and/or any of the sensor assemblies 14, 16, 18, 20. Each of the sensor assemblies 14, 16, 18, 20 could include a receiver for receiving data and/or control signals from the receiver 28, the transceiver 24 and/or any of the other sensor assemblies. It is not necessary for the telemetry system 12 to be positioned completely or partially in the wellbore 26. The receiver 28 and/or system 22 could be positioned at a remote location other than the earth's surface. It is not necessary for the wellbore 26 to be cased. Thus, it should be clearly understood that the invention is not limited in any manner to the details of the well system 10 or telemetry system 12 described herein.

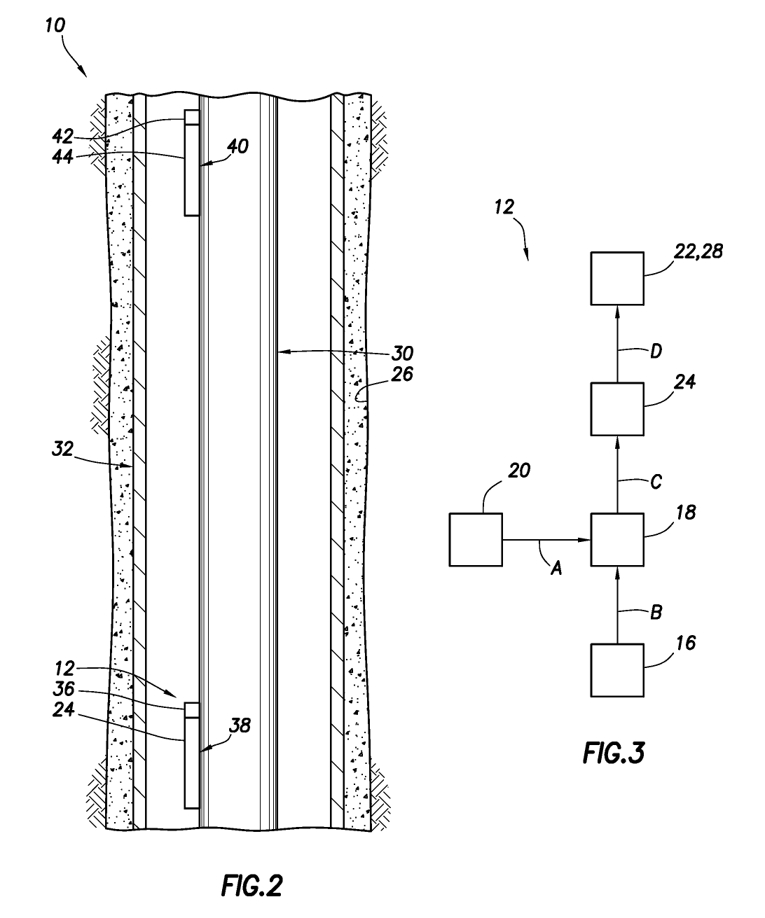

Referring additionally now to FIG. 2, an alternate configuration of the well system 10 and telemetry system 12 is representatively illustrated. In this configuration the transceiver 24 has a sensor 36 incorporated therewith. The sensor 36 could be hardwired or otherwise directly connected to the transceiver 24, so that a separate transmitter is not needed for communication between the sensor and the transceiver.

In this manner, the combined sensor 36 and transceiver 24 may form an additional sensor assembly 38 in the telemetry system 12. However, in this case the sensor assembly 38 is configured for long-range, rather than short-range, transmission.

Additional sensor assemblies 40 may be used to relay data and/or control signals between the transceiver 24 and the surface system 22. Preferably, each of these additional sensor assemblies 40 also includes a sensor 42 and a long-range transceiver 44. In this manner, additional sensor data may be obtained as the signals are relayed between the transceiver 24 and the surface system 22.

The sensor assemblies 14, 16, 18, 20, 38, 40 described above may be used to sense and monitor any parameter or combination of parameters of interest associated with the wellbore 26 and surrounding formation 34. Examples of such parameters include pressure, temperature, water cut, fluid composition, resistivity, capacitance, radioactivity, etc.

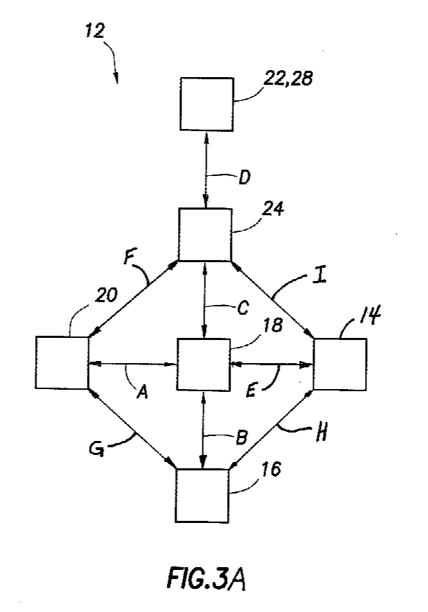

Referring additionally now to FIG. 3, the telemetry system 12 is schematically illustrated in a configuration in which a decentralized communication method is utilized. In this configuration, one of the sensor assemblies 18 is used to relay signals between other sensor assemblies 16, 20 and the transceiver 24.

This signal relaying would preferably be via a short-range transmission mode. The transceiver 24 preferably communicates with the receiver 28 via a long-range transmission mode.

In this manner, the sensor assemblies 16, 20 do not have to be within short-range transmission distance of the transceiver 24. Instead, the sensor assemblies 16, 20 only need to be within short-range transmission distance of another sensor assembly 18 which, in turn, is within short-range transmission distance of the transceiver 24.

It will be appreciated that this decentralized configuration enables the sensor assemblies 14, 16, 18, 20 to be widely distributed, while remaining in communication with the transceiver 24 and still using only short-range wireless transmission modes. This represents a significant advance in convenience and economy over prior methods wherein only long-range wireless and hardwired transmission modes were utilized.

Another, somewhat similar, decentralized communication method and configuration of the telemetry system 12 is schematically illustrated in FIG. 3A. In this configuration, each of the sensor assemblies 14, 16, 18, 20 may be in communication with any of the other sensor assemblies and/or with the transceiver 24.

This communication may be two-way (i.e., both reception and transmission) for each of the sensor assemblies 14, 16, 18, 20 and the transceiver 24. Note that in all of the methods and configurations described herein, any communication between elements can be either one-way or two-way, as desired.

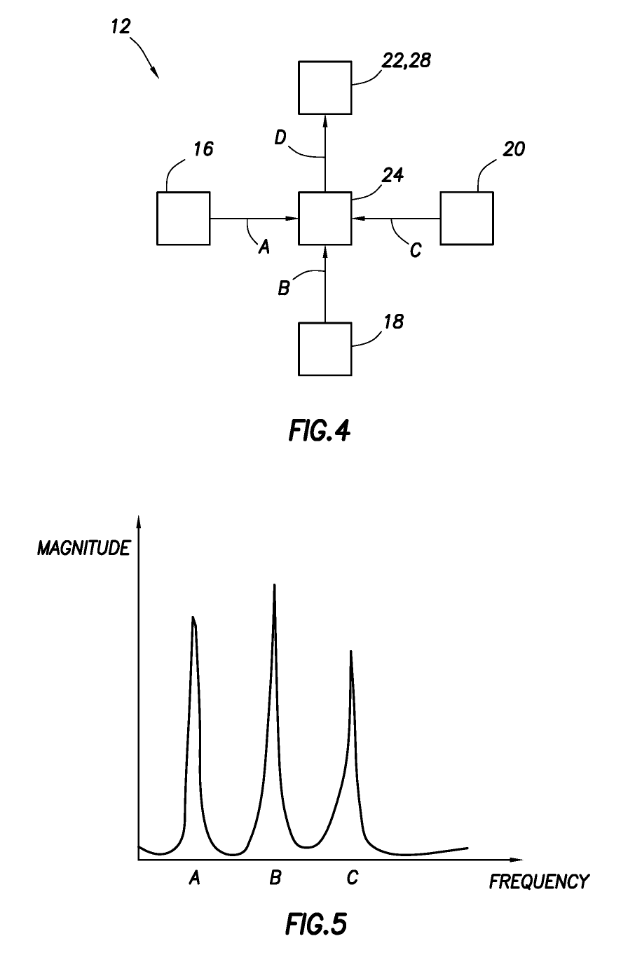

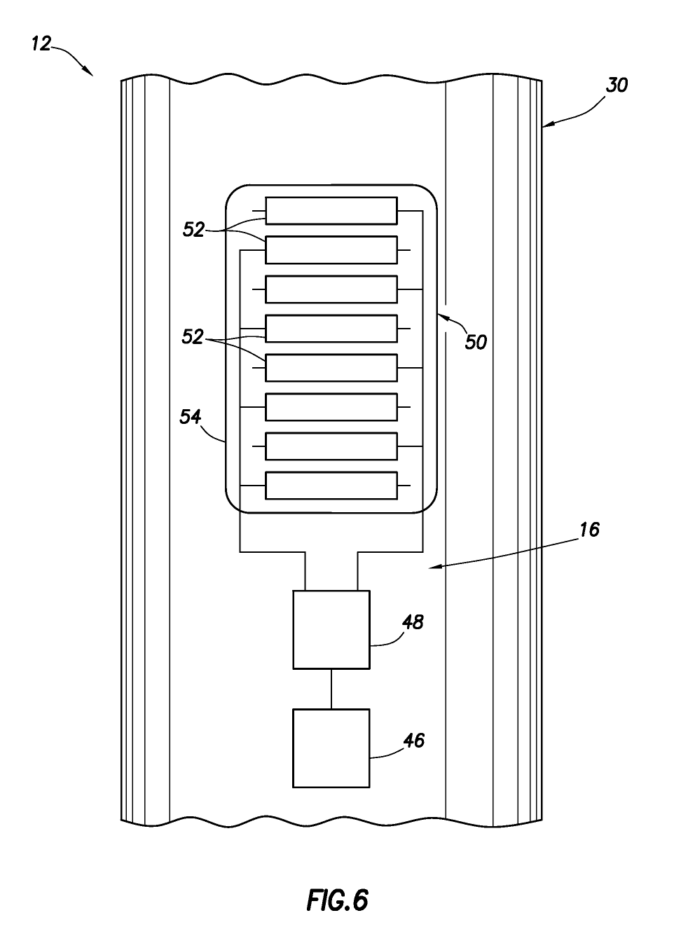

As with the configuration of FIG. 4, the configuration of FIG. 3A enables the sensor assemblies 14, 16, 18, 20 to be widely distributed while remaining in communication with the transceiver 24 via only short-range wireless transmission modes. Any of the sensor assemblies 14, 16, 18, 20 may be used to relay a signal between any of the other sensor assemblies and the transceiver 24, and any of the sensor assemblies may be capable of direct communication with the transceiver and/or any of the other sensor assemblies.

Referring additionally now to FIG. 4, the telemetry system 12 is schematically illustrated in a configuration in which a more centralized communication method is utilized. In this configuration, each of the sensor assemblies 16, 18, 20 communicates with the transceiver 24 via a short-range transmission mode, and the transceiver communicates with the receiver 28 via a long-range transmission mode.

This more centralized communication method does require that each of the sensor assemblies 16, 18, 20 be within short-range transmission distance of the transceiver 24, but it has the advantage that none of the sensor assemblies needs to have the capability of relaying signals from any other sensor assembly. Thus, the method of FIG. 4 may be less complex and more economical in practice as compared to the methods of FIGS. 3 & 3A.

For the short-range signal transmission modes described herein, preferably electromagnetic or acoustic transmission modes are used. The short-range acoustic transmission modes would preferably be via flexural and/or shear acoustic stress waves transmitted through the tubular string 30 or other transmission medium.

For the long-range signal transmission modes described herein, preferably acoustic transmission modes are used. The long-range acoustic transmission modes would preferably be via axial and/or torsional acoustic stress waves transmitted through the tubular string 30 or other transmission medium.

Electromagnetic and acoustic transmission modes for wireless telemetry are well known to those skilled in the art. Thus, the principles underlying these wireless telemetry techniques are not described further herein.

In the methods depicted in FIGS. 3, 3A & 4, it may be desirable to permit simultaneous transmission of signals between the various sensor assemblies 14, 16, 18, 20, the transceiver 24 and the receiver 28. In this case, it would be advantageous to be able to conveniently differentiate the signal transmissions from each other.

Representatively illustrated in FIG. 5 is a method whereby multiple signals A, B, C may be differentiated on the basis of transmission frequency. As depicted in FIG. 5, each of the signals A, B, C is transmitted predominantly at a unique frequency. The signals A, B, C may overlap somewhat, but for each signal, the transmission energy is greatest at a certain frequency which is different from that of the other signals.

In the decentralized telemetry system 12 configurations of FIGS. 3 and 3A, for example, the signal A could be transmitted from the sensor assembly 20 to the sensor assembly 18 at one predominant frequency, the signal B could be transmitted from the sensor assembly 16 to the sensor assembly 18 at another predominant frequency, and the signal C (e.g., combining data from each of the sensor assemblies 16, 18, 20) could be transmitted from the sensor assembly 18 to the transceiver 24 at yet another predominant frequency. A signal D could be transmitted from the transceiver 24 to the receiver 28 at still another predominant frequency, or using a different transmission mode.

The sensor assembly 18 could be programmed (either before or after installation) to relay only the signals A, B to the transceiver 24. Similarly, the transceiver 24 could be programmed to relay only the signal C in the transmitted signal D. Similar relaying and signal differentiation techniques may also be utilized for the additional signals E, F, G, H, I in the configuration of FIG. 3A.

In the more centralized telemetry system 12 configuration of FIG. 4, the transceiver 24 could be programmed to relay each of the signals A, B, C in the signal D. Note that none of the sensor assemblies 16, 18, 20 requires any such programming to relay signals.

In an alternative method of differentiating between the signals A, B, C, D, each of these signals could include a unique code, such as a prefix, which identifies the particular sensor assembly 16, 18, 20, transceiver 24 or receiver 28 from which the signal originates. This would be similar in some respects to a CDMA multiplexing technique. Other multiplexing techniques may be used in keeping with the principles of the invention.

Referring additionally now to FIG. 6, an enlarged schematic view of the sensor assembly 16 is representatively illustrated. In this view it may be seen that the sensor assembly 16 includes a sensor 46, electronic circuitry 48 and a piezoceramic array 50. The invention, however, is not limited to use of acoustic communication and may use electromagnetic or other telemetry methods which do not use piezoceramics.

The sensor 46 may be any type of sensor for detecting one or more parameters of interest. The electronic circuitry 48 receives indications of the parameter value from the sensor 46, processes this information, performs signal processing and appropriately drives the piezoceramic array 50.

The piezoceramic array 50 includes electromagnetically active material 52 arranged with a flexible film or membrane 54 for convenient attachment to the surface of a transmission medium, such as the tubular string 30. When driven appropriately by the circuitry 48, acoustic stress waves are imparted to the transmission medium by the piezoceramic array 50. Preferably, the acoustic stress waves are relatively high amplitude and high frequency flexural waves for short-range and relatively high data rate signal transmission to the transceiver 24.

The use of thin piezoceramics for acoustic signal transmission and reception is described in copending U.S. application Ser. No. 10/409,515, published as US 2004-0200613, and the entire disclosure of which is incorporated herein by this reference.

Note that the array 50 and circuitry 48 may also function as a receiver to receive signal transmissions from the other sensor assemblies 14, 18, 20, the transceiver 24, or even the receiver 28 (which may include a transmitter as described above). In this case the array 50 may respond to stress waves in the transmission medium by generating electrical pulses which are detected by the circuitry 48.

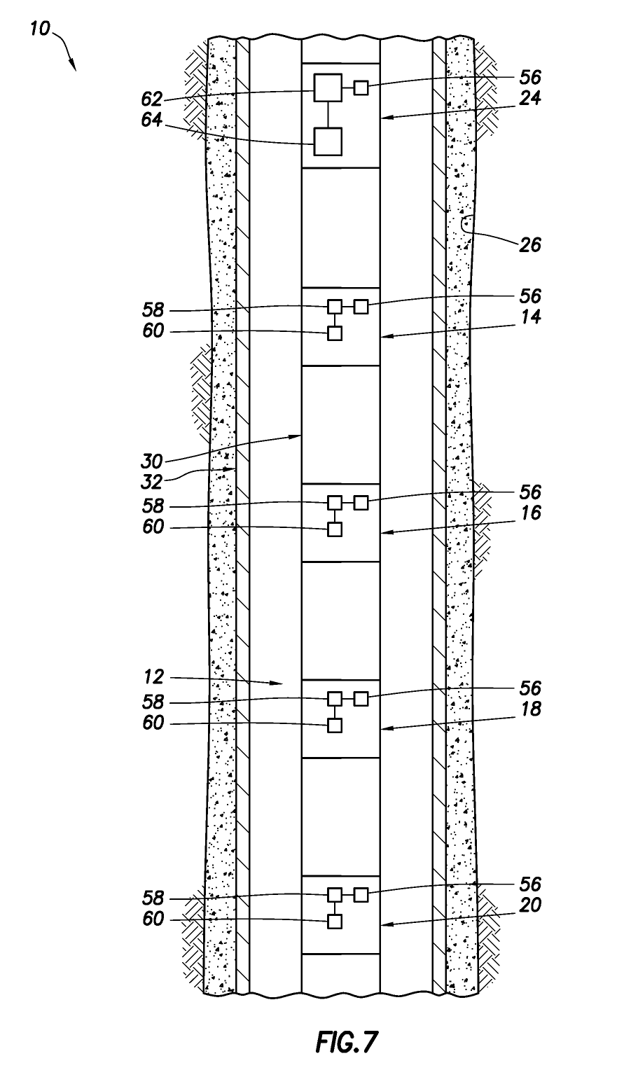

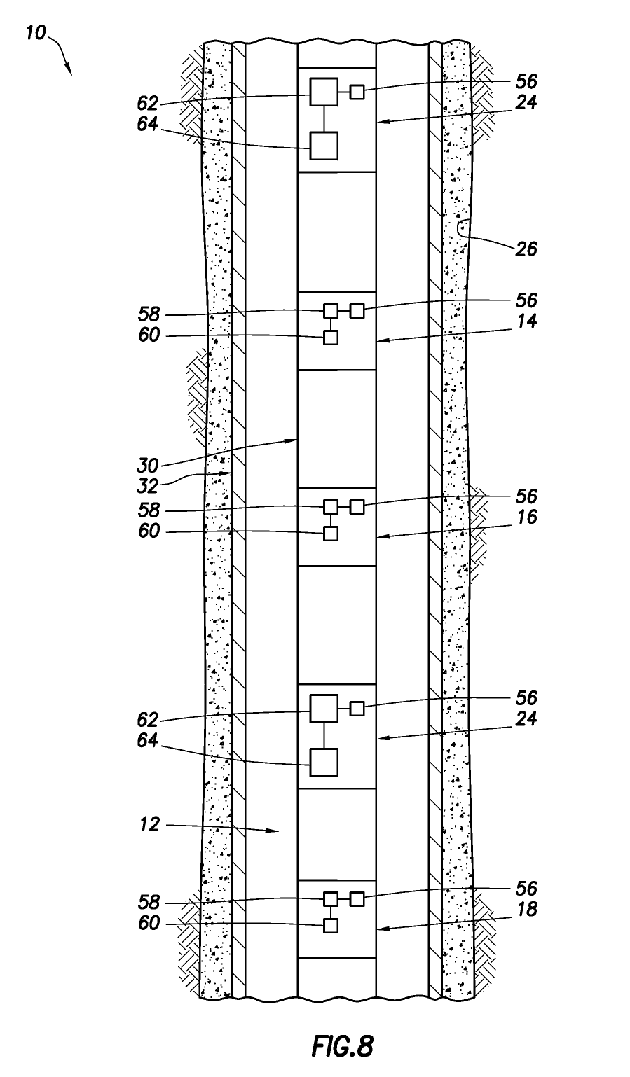

Referring additionally now to FIG. 7, a useful application of the principles of the invention is representatively illustrated in an alternate configuration of the well system 10. In this configuration, the transceiver 24 and each of the sensor assemblies 14, 16, 18, 20 are interconnected in the tubular string 30.

In addition, each of the transceiver 24 and the sensor assemblies 14, 16, 18, 20 includes a sensor 56. The sensors 56 may all be the same type of sensor, or they may be different types of sensors. The sensors 56 may detect one or more parameters of interest.

Each of the sensor assemblies 14, 16, 18, 20 includes a transmitter 58 and a receiver 60. As described above for the configuration of the sensor assembly 16 depicted in FIG. 6, the transmitter 58 and receiver 60 may be combined, or they may be completely or partially separate components.

The transmitters 58 and receivers 60 are preferably configured for short-range communication. However, the transceiver 24 includes a transmitter 62 and receiver 64 configured for long-range communication.

One advantage of the configuration of the well system 10 depicted in FIG. 7 is that the sensors 56 can provide distributed sensing of certain parameters (such as pressure and/or temperature), so that a profile of the parameter(s) along the wellbore 26 can be detected. For example, it would be useful to be able to monitor a temperature or pressure profile along the wellbore 26 during stimulation treatments, gravel packing, water or steam injection, production or other operations.

In the telemetry system 12 as depicted in FIG. 7, sensor data may be transmitted by short-range transmission from the sensor assembly 20 to the sensor assembly 18. Additional sensor data from the sensor 56 of the sensor assembly 18 is combined with the sensor data from the sensor assembly 20 and is transmitted by short-range transmission to the sensor assembly 16. Additional sensor data from the sensor 56 of the sensor assembly 16 is combined with the sensor data from the sensor assemblies 18, 20 and is transmitted by short-range transmission to the sensor assembly 14. Additional sensor data from the sensor 56 of the sensor assembly 14 is combined with the sensor data from the sensor assemblies 16, 18, 20 and is transmitted by short-range transmission to the transceiver 24. Additional sensor data from the sensor 56 of the transceiver 24 is combined with the sensor data from the sensor assemblies 14, 16, 18, 20 and is transmitted by long-range transmission to the receiver 28.

The receiver 60 of each sensor assembly 14, 16, 18, 20 facilitates this relaying of sensor data to the transceiver 24. In addition, the receivers 60 may be used to receive transmissions from the transceiver 24 and/or from the receiver 28 and surface system 22, for example, to program the sensor assemblies 14, 16, 18, 20 to receive and/or transmit at certain frequencies as described above.

Referring additionally now to FIG. 8, yet another alternate configuration of the well system 10 is representatively illustrated. This configuration is similar to the FIG. 7 configuration, but differs in at least one respect in that multiple transceivers 24 are utilized in the tubular string 30.

An upper transceiver 24 is associated with an upper set of the sensor assemblies 14, 16, and a lower transceiver 24 is associated with at least one other sensor assembly 18. In this manner, the upper transceiver 24 may be used for long-range transmission of the sensor data from the sensor assemblies 14, 16 and the upper transceiver, and for otherwise long-range communication with the receiver 28 and lower transceiver 24, while the lower transceiver may be used for long-range transmission of the sensor data from the sensor assemblies 18 and the lower transceiver, and for otherwise long-range communication with the receiver 28 and upper transceiver. The upper transceiver 24 may, for example, serve as a repeater for transmissions between the lower transceiver and the receiver 28, while also providing short-range communication with the sensor assemblies 14, 16.

It may now be fully appreciated that the present invention provides for convenient and economical wireless communication. In the various configurations of the well system 10 described above, communication with multiple sensor assemblies is accomplished in a manner which incorporates the benefits of short-range telemetry with those of long-range telemetry. Multiple sensors can be widely distributed in a variety of locations, without the problems associated with hardwiring the sensors to a central transmitter. In addition, the short-range transmission modes described above permit greater rates of data transfer than conventional long-range transmission modes.

Any of the sensor assemblies 14, 16, 18, 20, 38, 40 described above may include a combination of a sensor and a transmitter and/or a receiver. The transmitter and receiver may be combined into a single transceiver, or they may be separate components or share only certain elements. Any of the sensor assemblies 14, 16, 18, 20, 38, 40 may also include other components, such as actuators, well tools, etc., which may be actuated or otherwise operated in response to the signal communications described above, or operation of which may be monitored via the signal communications described above.

Any transmitter described herein could also include a receiver, and any receiver described herein could also include a transmitter. Any description herein of transmission of a signal from one component to another should be understood to include the capability of transmission of the same, a similar or a different signal in the opposite direction.

Of course, a person skilled in the art would, upon a careful consideration of the above description of representative embodiments of the invention, readily appreciate that many modifications, additions, substitutions, deletions, and other changes may be made to these specific embodiments, and such changes are within the scope of the principles of the present invention.

Accordingly, the foregoing detailed description is to be clearly understood as being given by way of illustration and example only, the spirit and scope of the present invention being limited solely by the appended claims and their equivalents.

What is claimed is:

1. A telemetry system, comprising:
multiple sensor assemblies, each sensor assembly including at least one sensor and a sensor data transmitter; and
a transceiver which receives sensor data from each of the transmitters.

2. The telemetry system of claim 1, wherein the transceiver receives the sensor data directly from the multiple transmitters.

3. The telemetry system of claim 1, wherein the transceiver receives the sensor data from a first one of the transmitters relayed by a second one of the transmitters.

4. The telemetry system of claim 1, wherein each transmitter transmits at a different predominant frequency.

5. The telemetry system of claim 1, wherein the transceiver transmits at a unique predominant frequency.

6. The telemetry system of claim 1, wherein each transmitter transmits a signal containing a unique code.

7. The telemetry system of claim 1, wherein the transceiver transmits a signal containing a unique code.

8. The telemetry system of claim 1, wherein the transmitters transmit to the transceiver using a first signal mode, and wherein the transceiver transmits to a remote location using a second signal mode different from the first signal mode.

9. The telemetry system of claim 8, wherein the first mode is via at least one of flexural and shear acoustic stress waves.

10. The telemetry system of claim 8, wherein the second mode is via at least one of axial and torsional acoustic stress waves.

11. The telemetry system of claim 8, wherein the first mode is via electromagnetic waves, and wherein the second mode is via acoustic stress waves.

12. The telemetry system of claim 1, wherein the sensors detect at least one of pressure and temperature associated with a subterranean wellbore.

13. The telemetry system of claim 12, wherein the sensors are spaced apart along the wellbore, thereby providing at least one of a pressure profile and a temperature profile along the wellbore.

14. An acoustic telemetry system, comprising:
multiple transmitters; and
a transceiver,
wherein the transmitters transmit to the transceiver using a first acoustic signal mode, and wherein the transceiver transmits to a remote location using a second acoustic signal mode different from the first acoustic signal mode.

15. The telemetry system of claim 14, wherein the first mode is via at least one of flexural and shear acoustic stress waves.

16. The telemetry system of claim 14, wherein the second mode is via at least one of axial and torsional acoustic stress waves.

17. The telemetry system of claim 14, wherein the transceiver receives data directly from the multiple transmitters.

18. The telemetry system of claim 14, wherein the transceiver receives data from a first transmitter relayed by a second transmitter.

19. The telemetry system of claim 14, wherein each transmitter transmits at a different predominant frequency.

20. The telemetry system of claim 14, wherein the transceiver transmits at a unique predominant frequency.

21. The telemetry system of claim 14, wherein each transmitter transmits a signal containing a unique code.

22. The telemetry system of claim 14, wherein the transceiver transmits a signal containing a unique code.
